(19) United States
(12) Patent Application Publication
(10) Pub. No.: US 2006/0174385 A1
(43) Pub. Date: Aug. 3, 2006

(54) Method and apparatus for detecting targets

(76) Inventors: Lewis Gruber, Chicago, IL (US); Joseph Plewa, Park Ridge, IL (US); Misty Gruber, Chicago, IL (US)

Correspondence Address: AKERMAN SENTERFITT, 801 PENNSYLVANIA AVENUE N.W., SUITE 600, WASHINGTON, DC, 20004, US

(21) Appl. No.: 11/048,059

(22) Filed: Feb. 2, 2005

(51) Int. Cl. G01N 23/00

(52) U.S. Cl. 977/874

(57) ABSTRACT

A nano-sensor for sensing one or more targets has a plurality of sensor units, each including a nano-structure and an encapsulating sensible medium surrounding the nano-structure. Each nano-sensor unit being positioned by holographic optical trapping and operative to produce a signal output indicative of the presence of a particular target. A substrate has a sensor location for each sensor unit, each operative to produce an output in response to the signal from the corresponding sensor unit indicative of the presence of a particular target. The sensor may employ a disposable support for the sensor units adapted to be positioned in registration with the sensor locations and disposed of after use.

### CROSS REFERENCE TO RELATED APPLICATIONS

This application is related to U.S. patent application Ser. No. 10/974,976, filed Oct. 28, 2004, entitled System and Method for Manipulating and Processing Nano Materials using Holographic Optical Trapping, and U.S. patent application Ser. No. 10/428,785, filed May 5, 2003, entitled Broad Spectrum Optically Addressed Sensor, the teachings of the above-identified applications are incorporated herein by reference.

### BACKGROUND OF THE INVENTION

The invention relates to a method and apparatus for detecting multiple targets; in particular to a disposable detector having a plurality of detector sites each employing nano-structures as active elements, adapted to sense a selected target or a conditional concentration thereof. The nano-structures are manipulated and assembled by optical trapping techniques.

Sensors for detecting various chemical or biological targets are known. One such sensor as set forth in Asher, U.S. Pat. No. 6,544,800 discloses a sensor composed of a crystalline colloidal array polymerized in a hydrogel. The hydrogel shrinks and swells in response to specific stimuli. As the hydrogels shrink or swell, the lattice structure of the colloidal array embedded therein changes thereby changing the wavelength of light diffracted by the crystalline colloidal array. The arrangement in Asher is assembled using conventional chemical techniques and is not conveniently or particularly adapted for use with nano manipulation techniques. Asher employs a functionalized gel and is thus limited in its broad application.

Charych et al., U.S. Pat. No. 6,022,748 discloses methods and compositions for the direct detection of analytes using color changes that occur in immobilized biopolymeric material in response to selective binding of analytes to their surface. Charych et al. particularly discloses methods and compositions related to the encapsulation of biopolymeric material into metal oxide glass using the sol-gel method. Charych is likewise limited to self-assembling monomers and functionalized gels and is generally limited to the collection of one species.

Grier et al. U.S. patent application Ser. No. 10/428,785 discloses a method and apparatus for detecting targets using functionalized colloidal beads encapsulated in the gel matrix secured to the end of the fiber optic. Although useful for its intended purposes, the device was constrained by bandwidth limitations.

### SUMMARY OF THE INVENTION

The present invention is based on the discovery that a nano-sensor comprising at least one pair of nano-structures encapsulated in a surrounding sensible medium is operative to produce an output indicative of the presence of a particular target. A substrate having a plurality of sensor locations, one for each nano-structure pair is operative to produce an output in response to an input from the nano-sensor to thereby identify a target of interest. In a particular embodiment, the nano-structure comprises a pair of nanotubes. The interaction between nano-structures provides an indication of the presense or absence of a target material.

In one embodiment, the sensor locations comprise microcircuits disposed on the substrate. In particular, the microcircuits include an electronic switch responsive to the signal from corresponding pair of nano-structures.

In accordance with the present invention, the nano-sensor is assembled using optical trapping techniques whereby the nano structures and the sensible medium are positioned at corresponding sensor locations on a substrate.

In an exemplary embodiment, the nano-sensor is disposable and is adapted for one-time use in various commercial applications.

### BRIEF DESCRIPTION OF THE DRAWINGS

FIG. 1. is a perspective view of an exemplary embodiment of the invention.

FIG. 2. is a detail in perspective of a sensor unit.

FIG. 2A is a schematic representation of a bundle of nanotubes in a sensor element.

FIG. 3A-3B are schematic representations of nanotubes in spaced apart and closely proximate arrangements respectively.

FIG. 4A-4C are schematic representations of functionalized nanotubes, functionalized gel and functionalized beads.

FIG. 5 is a schematic representation of an electronic switch.

FIG. 6 is a schematic representation of a disposable sensor.

FIG. 7 is a schematic block diagram of a hand held sensor coupled to a microprocess and display.

FIG. 8 is a schematic representation of an optical sensor according to another embodiment of the invention.

FIG. 9 is a schematic representation of a disposable sensor supports on a perforated roll.

FIG. 10 is a schematic representation of a disposable sensor with woven patches of nanotubes lying parallel to the surface of the fabric.

FIG. 11 is a schematic representation of a disposable sensor formed of long nanotubes woven into a fabric having separate sensor areas.

### DESCRIPTION OF THE INVENTION

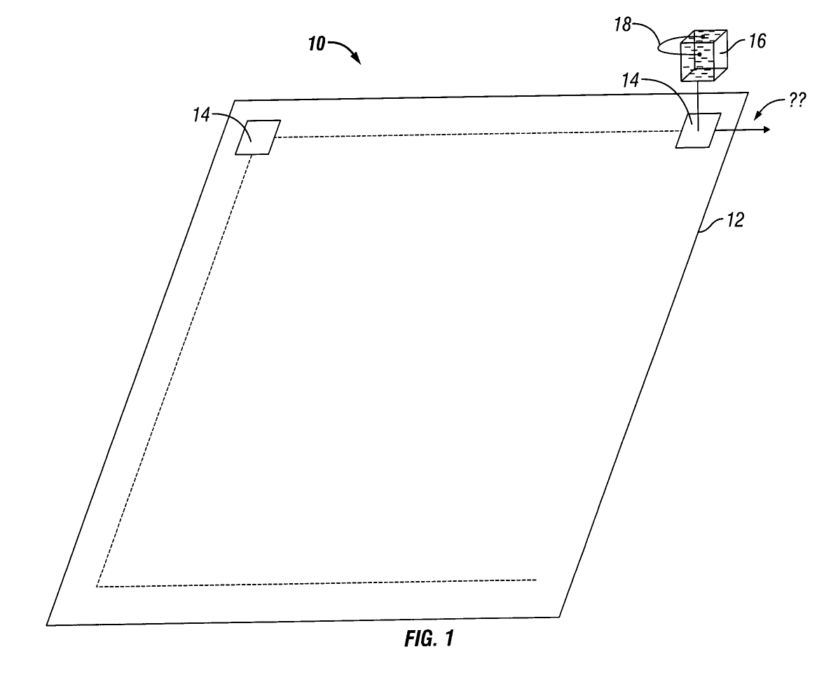

FIGS. 1-6 schematically illustrate the nano-sensor 10 in accordance with the present invention. The nano-sensor 10 comprises a substrate 12 having a plurality of sensor locations 14 disposed thereon. The sensor locations 14 are arranged on the substrate in an N×N array.

A sensor unit 16 is located in each sensor location 14. Each sensor unit 16 may be responsive to the presence of a particular target (inorganic, organic or biological target). Each sensor unit 16 comprises at least two nano-structures 18, i.e., particles in the known nano regime, supported in spaced relationship in a gel matrix 20 which surrounds and encapsulates the nano-structures. In accordance with an exemplary embodiment of the invention, and as illustrated herein, each nano-structure comprises a nanotube 18. It should be understood that other known nano-structures such as particles, beads, wire and various molecular structures may be used.

In accordance with the invention, the nano-structures or nanotubes 18, the gel 20 or both may be functionalized to be responsive to the presence of a particular target.

In an alternatiave embodiment, the sensor unit 16 may also employ bead elements 22 comprising beads uniformly dispersed in and suspended in the gel matrix 20. The bead elements 22 may likewise be functionalized if desired upon the application. In such an arrangement, the beads 22 provide pathways for communication between the pair of nano-structures.

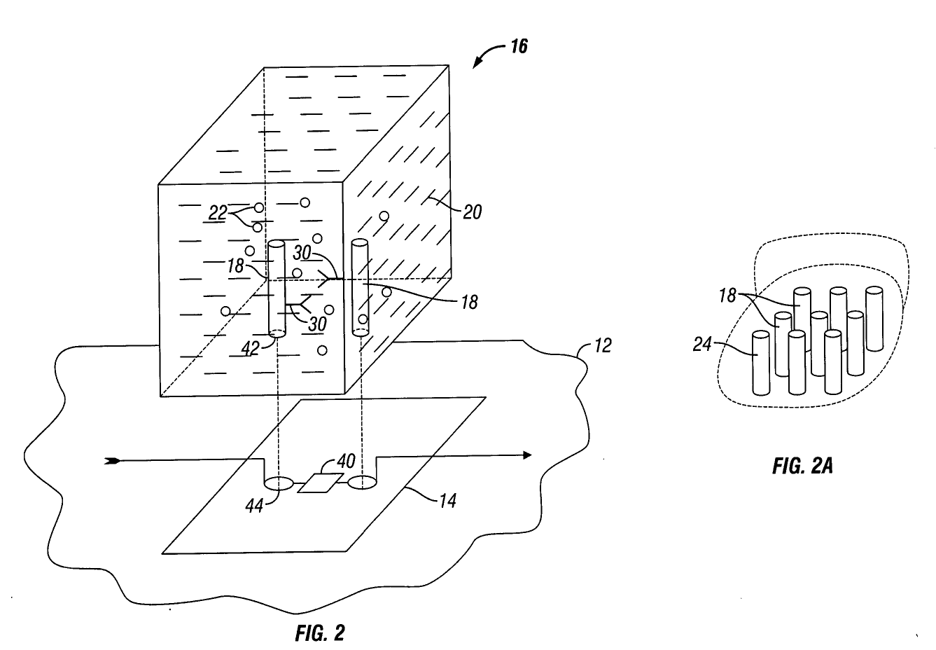

It should be understood that a bundle of nanotubes 24 FIG. 2A may be employed in a more dense population of sensor elements if desired. Such bundles of nanotubes may be analogized to bristles of a brush or twisted wires of a cable, or randomly twisted wires with gel between and among the various nano-tube elements with each bundle of nanotubes forming a sensor unit.

Nano-tubes are particularly useful as they have strong abrasion resistance, and as a sensor is swiped on a surface, the nano-tubes protect the gel matrix, particularly the gel between the tubes. Thus targets which are able to migrate to an area between the tubes are less likely to be abraded and lost.

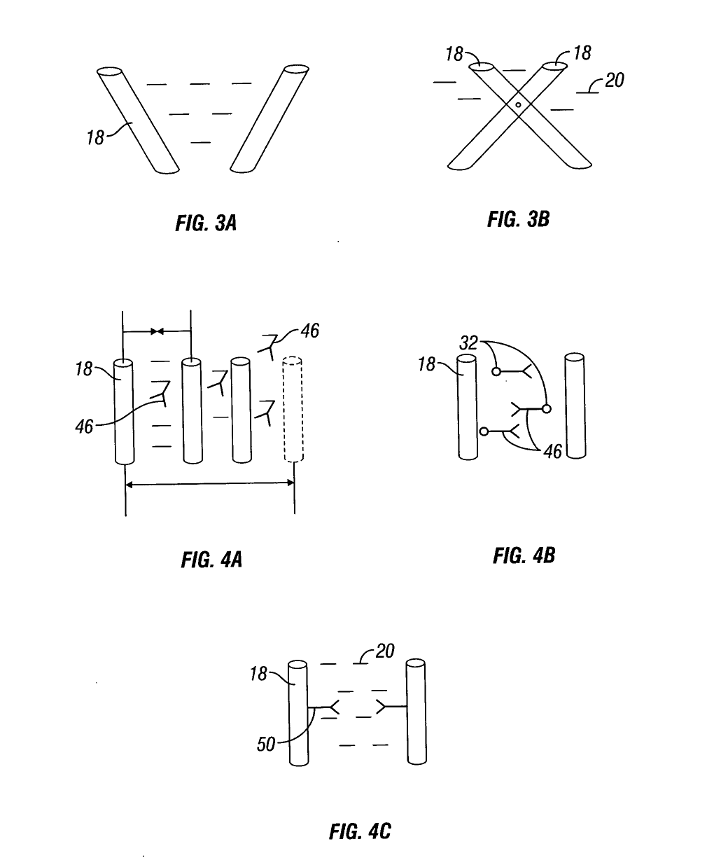

One or more functionalized species 30 may be attached to each nanotube 18 by known techniques. In the presence of a target species 32, gel 20 may swell or shrink, and the relative position or proximity of the nanotubes 18 may change. For example, the nanotubes 18 may be in contact and move farther apart FIG. 3A or the tubes may be out of contact and move close together and come into physical contact as illustrated in FIG. 3B.

It should be further understood that not only can the relative position of the tubes produce a sensible indication of a target, but also the functionalized elements may create a bridging effect to connect the tubes and thereby complete a circuit. Bridging includes antigen antibody reaction or DNA hybridization reaction. Also, the beads may clump as they do in a conventional blood test creating a bridge, or causing the relative positions of the tubes to change in a sensible way, i.e., any desired or measureable change in the position of the tubes can be exploited to provide a desired indication of a target.

Each sensor unit 16 is disposed over a corresponding sensor location 14. Each sensor location includes a microcircuit 40 adapted to be responsive to a corresponding nano-sensor unit 16. The nanotubes 18 may be physically attached at a proximate end 42 to corresponding contact 44 on the microcircuit. Alternatively, the end of the nanotube may be in spaced relation with the contact 44.

When, as illustrated in FIG. 3B, the nanotubes 18 contact each other, the microcircuit 40 is responsive to produce an output. Likewise if the nanotubes 18 become separated from each other and out of contact (FIG. 3B), the microcircuit may be adapted to produce a corresponding output as well.

It should be understood that as the constituent particle size decreases, the ratio of surface area to volume S/V increases for the same volume of particles, thereby increasing the sensitivity of the sensor. For a sensor with a desired surface area for detection, building the sensor from nanotubes rather than microparticles gives you a factor of 1000 or more decrease in sensor size. It is possible to achieve a relatively large surface area in a small detector volume. At the same time, it is possible to thereby increase the number of detector units on a single substrate.

In another embodiment (FIG. 4A), the gel 20 is functionalized by a functional species 46, such that, in the presence of a target 32, the gel swells or shrinks. In such an arrangement, the nanotubes 18 suspended in the gel matrix 20 likewise separate or become closely proximate in response to the change of the corresponding swelling and shrinking of the gel matrix. The change in the proximity of the nanotubes 18 results in a corresponding sensor output in the microcircuit 40.

In yet another embodiment (FIG. 4B), colloidal particles 22 may be suspended in the gel matrix. The colloidal particles may carry functionalized species 46 as well, thus the presence of a target 32 may cause the particles 22 to bridge the space between the nanotubes causing the completion of a molecular circuit. Such an arrangement tends to amplify the sensitivity of the system in that multiple particles tend to form clumps, or in some cases multiple bridges in the presence of the target species.

The nanotubes are also functionalized by species 46 (FIG. 4C) in order to enhance detection of the target species. The nanotubes 18, the gel 20 and the beads 32 may be selectively functionalized in any desired combination.

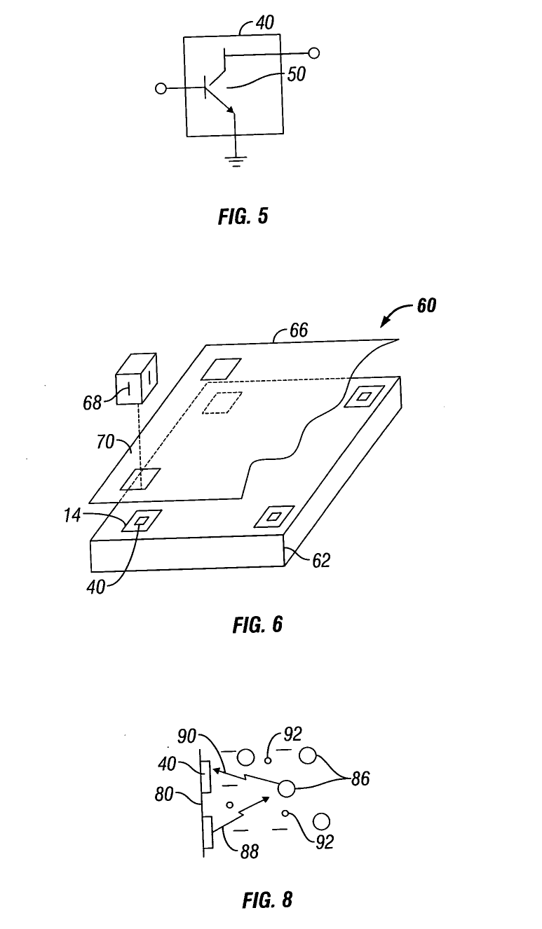

The sensor or microcircuit 40 may comprise an electronic switch 50 shown schematically in FIG. 5. Such switches, (e.g., transistors, FETs, CCD's and the like) are well known in the electronics industry. Assembly of arrays of switches may be assembled in customized or application specific integrated circuits (ASIC) containing many thousands of such devices by original equipment manufactures. Such an ASIC may contain 100×100 microcircuits or more depending upon the number of targets to be detected. Each sensor 16 unit may be functionalized to detect a different target; and each sensor location 14 produces an output to identify a particular species sensed by the corresponding sensor unit.

The relative spacing of the nanotubes may produce a corresponding change in the condition of the sensor unit. For example, the nanotubes may come into contact creating a short circuit. Such a short circuit may be detected at the input of a switch 50 causing it to conduct. Alternatively the switch may become open circuit, or the capacitance may change in any event, the condition of the switch is an indication of the presence or absence of the target species. It is also possible that the relative positionment of the nanotubes may provide an indication of the relative concentration of the target species in the medium. In such a case, the current through the switch would vary in accordance with the concentration.

In an alternative embodiment (FIG. 6) there may be provided with a sensor 60 having a nondisposable substrate 62 with sensor locations 64 formed thereon as described above. In accordance with the invention a disposable sensor 66 is formed by arranging sensor units 68 in an array on a disposable secondary substrate or disposable support 70. The disposable sensor 66 may be positioned with the individual sensor units 68 located in registration with the individual sensor locations 64. The disposable support may be a biocompatible material such as a flexible plastic substrate, manufactured by Plastic Logic Cambridge UK, having arrays of conductors 67 printed or deposited thereon. Each sensor unit may be registerably positioned in contact with a corresponding conductor 67 and sensor location 64 as shown.

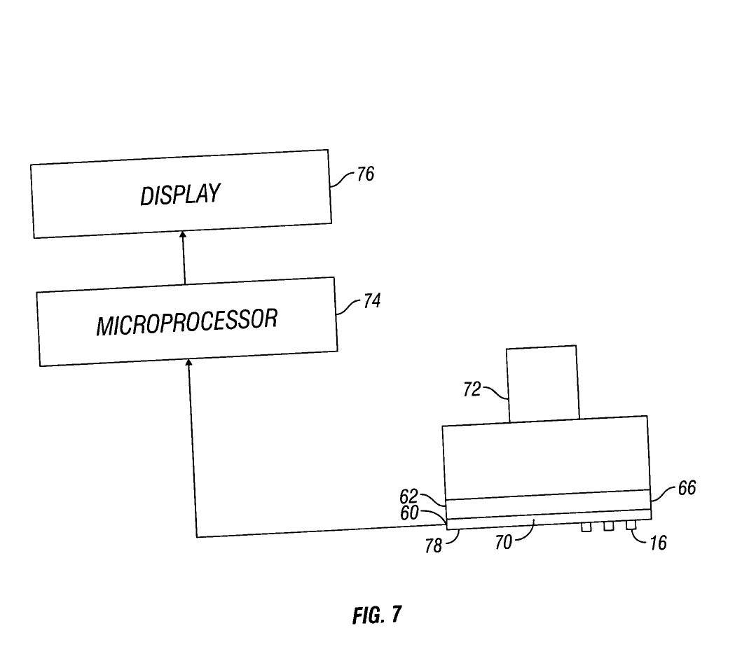

As shown in FIG. 7, the substrate 62 and disposable sensor 66 may be secured in a relatively small (e.g. 1″ sq) hand-held device 72 coupled to a microprocessor 74 having display 76. The active surface 78 of the sensor device may be placed in or on a suface interest, and if target species are detected, individual sensor locations provide a signal which is coupled to micrcoprocessor for analysis. Once the test is performed, the support and the sensor units may be removed from the substrate and a fresh sensor element may be positioned thereon for a different test or a new test in a different area.

High density (e.g. 10,000 sensor/in²) of sensor units 16 and 60 may be assembled and secured to respective substrates 12 and 62 using optical trapping techniques as set forth in the above-identified application Ser. No. 10/974,976. An apparatus implementing optical trapping may be a BioRyx® system manufactured by Arryx, Inc. In such an arrangement, the gel may be formulated with or without functional elements and the nanotubes may be selectively positioned in pairs at each sensor location. If desired functionalized or non-functionalized colloidal beads may be dispersed in the gel material as well.

In accordance with the invention, the optical trapping system may be employed to position each pair of nanotubes in spaced relationship and positioned proximate to a corresponding sensor location on the substrate. The gel may be thereafter deposited on the substrate. Alternatively, a sensor unit may be formed by positioning the nanotubes within the gel matrix and then using optical trapping to surround and sever individual sensor units for disposition on the substrate.

Various mechanisms may be employed to produce an output from the sensor units for each sensor location. The various mechanisms include forming a molecular or physical contact between the nanotubes, bridging the space between the nanotubes with clumpped or bridging bead elements which trap the target species and which form a bridge between the nano-structures.

In addition, the gel may swell or shrink causing the nanotubes to separate or move into closer proximity respectively. If the gel material is conductive or semi-conductive, the spacing of the nanotubes will provide an indication of the relative concentration of the target materials. Alternatively, the spacing may establish a capacative response of the nanotubes which may be sensed by the microcircuit. At least one of the nanotubes, the gel medium, and the colloidal beads are functionalized to attract target species. If more than one of these elements is functionalized, the response may be amplified or improved for greater sensitivity.

An optical element such as a photodiode 80 (FIG. 8) may produce light for exciting the space 82 between nanotubes or nanostructures 86. A change in the configuration of the space either by swelling or shrinking causes a change in the refraction or reflection of light 88 entering the region. Such refracted or reflected light 98 from the nanostructures may be sensed by the photo detector 88 to provide an indication of the presence or absence of a target species. The photodiode 80 and photodetector 88 may be an implemention of a microcircuit disposed on a substrate.

Alternatively, target species attracted to the space between the nanotubes may be responsive to the light from the photodiode causing a fluorescence response which may be sensed by the photo detector. The intensity and duration of the response may also provide an indication of the concentration of the target species. Nano-particles 92 may also be located in the space between the nanotubes to amplify the light reflected by the target species.

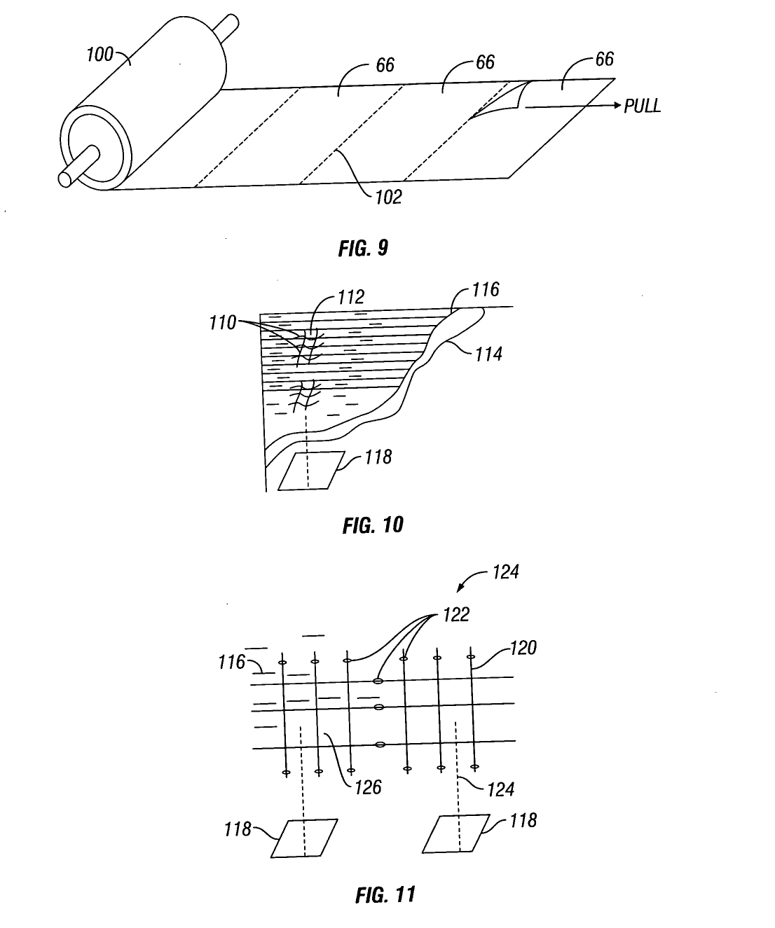

In another embodiment, the disposable sensor support with disposable sensor units disposed thereon may be in the form of a roll 100 having perforated lines 102 of such supports 66. The supports 66 may be separated by a pull force to tear the perforated line as shown in FIG. 9.

In yet another embodiment, shown in FIG. 10, nanotubes may be woven like a fabric with woven patches 112 of nanotubes integrated into a fabric carrier 114 in a gel 116 matrix. As a result, the long surface of each nanotubes is exposed to the environment. Each patch 112 forms a sensor unit to be registered with respect to a corresponding sensor location 118. Such an arrangement may also be conveniently formed as a disposable sheet as described above. It may also be possible to form long nanotubes 120 (FIG. 11) each having inert or non-conductive blocking elements 122, so that an arrays of tubes may be woven into a continuous fabric 124 formed with separate sensor locations 126 for registration with the corresponding contact 121 and sensor locations 118. The woven fabric may be part of a gel matrix or coated with gel 116 and form a disposable sensor support.

It should also be understood one of the advantages of using bundles of tubes, as shown in FIG. 2A, or a network of woven tubes as shown in FIGS. 10 and 11 is that they can be tailored for a quick response so the very few particles close a conductivity pathway.

We claim:

1. A nano-sensor for sensing one or more targets comprising:
a plurality of sensor units, each including a nano-structure and an encapsulating sensible medium surrounding the nano-structure, each of said nano-sensor units being operative to produce a signal output indicative of the presence of a particular target;
a substrate having a plurality of sensor locations, one for each sensor unit, each sensor location operative to produce an output in response to the signal from the corresponding sensor unit indicative of the presence of a particular target.

2. The nano-sensor according to claim 1 wherein the sensor units are disposed on the substrate.

3. The nano-sensor according to claim 1, further including a support for the plurality of sensor units, said support adapted to be removably positioned on the substrate with the sensor units in the support in registration with the corresponding sensor locations on the substrate.

4. The nano-sensor according to claim 3, wherein the support and sensor units are disposable.

5. The nano-sensor according to claim 1, wherein the nano-structures are functionalized to be responsive to a particular target.

6. The nano-sensor according to claim 5, wherein each of nano-structure produces an output in accordance its spatial configuration.

7. The nano-sensor according to claim 1, wherein each nano-structure comprises at least two nanotubes

8. The nano-sensor according to claim 7, wherein the nanotubes are operative to contact each other to complete a circuit, or to separate from each other to produce an open circuit in the presence of a particular target.

9. The nano-sensor according to claim 1, wherein each nano-structure comprises a plurality of nanotubes clustered in a bundle.

10. The nano-sensor according to claim 1, wherein each nano-structure comprises a woven fabric of nano-tubes.

11. The nano-sensor according to claim 1, wherein the sensible medium comprises a gel for supporting the nano-structure in a selected spatial configuration and being responsive in the presence of the target for causing the nano-structures to vary their relative proximity to each other.

12. The nano-sensor according to claim 1, wherein the substrate comprises a microcircuit.

13. The nano-sensor according to claim 11, wherein the microcircuit comprises an electronic switch for each sensor location.

14. The nano-sensor according to claim 12, wherein each sensor location on the microcircuit includes an electronic switch responsive to the relative proximity of the nano-structures.

15. The nano-sensor according to claim 1, further including logic means responsively coupled to the sensor locations for identifying the sensed target outputs.

16. The nano-sensor according to claim 1, wherein including the colloidal beads disposed in the matrix.

17. The nano-sensor according to claim 1, wherein at least one of the nano-structures, the gel medium, and the beads are functionalized to be responsive to a particular target.

18. The nano-sensor according to claim 1, wherein the sensor unit comprises an optical source and an optical sensor, the optical source for producing an illumination signal into the medium and the optical detector for detecting reflected, refracted or fluorescent light from the medium indicative of a target species.

19. The nano-sensor according to claim 1, wherein the substrate comprises a plurality of disposable supports for the sensor units, said supports being in the form of a perforated roll.

20. A nano-sensor for sensing a plurality of targets comprising:
a plurality of sensor units, each including a nano-structure and an encapsulating sensible medium surrounding the nano-structure, each of said nano-sensor units being positioned by holographic optical trapping and operative to produce a signal output indicative of the presence of a particular target;
a substrate having a plurality of sensor locations, one for each sensor unit, each sensor location operative to produce an output in response to the signal from the corresponding sensor unit indicative of the presence of a particular target.
